(19) United States
(12) Patent Application Publication
(10) Pub. No.: US 2018/0297107 A1
(43) Pub. Date: Oct. 18, 2018

(54) MACHINING SYSTEM FOR AIRCRAFT STRUCTURAL COMPONENTS

(71) Applicant: Broetje-Automation GmbH, Rastede (DE)

(72) Inventor: Christian Meiners, Oldenburg (DE)

(21) Appl. No.: 15/569,357

(22) PCT Filed: Apr. 28, 2016
(86) PCT No.: PCT/EP2016/059480

§ 371 Date: Oct. 25, 2017

(30) Foreign Application Priority Data
Apr. 28, 2015 (DE) 10 2015 106 543.6

(51) Int. Cl. B21J 15/14; B64F 5/10; B23B 41/00; B23Q 1/52

(52) U.S. Cl. CPC B21J 15/142; B64F 5/10; B23B 2215/04; B23Q 1/525; B23B 41/006

(57) ABSTRACT

The disclosure relates to a machining system for aircraft structural components, comprising a first frame for mounting a workpiece, and a second frame for mounting a tool pair including an upper tool and a lower tool cooperating therewith. The workpiece is positioned between the upper tool and the lower tool. The second frame is formed to be displaceable at least in a longitudinal direction with respect to a base. The tool pair is held in the second frame such that it is displaceable in a transverse direction which is at an angle to the longitudinal direction. The second frame is held on at least one swivel bearing so that the second frame can be adjustably swiveled together with the tool pair about a swivel axis.

### CROSS-REFERENCE TO RELATED APPLICATIONS

This application is a national stage application under 35 U.S.C. 371 of International Patent Application Serial No. PCT/EP2016/059480, entitled “MACHINING SYSTEM FOR AIRCRAFT STRUCTURAL COMPONENTS,” filed Apr. 28, 2015, which claims priority from German Patent Application No. DE 10 2015 106 543.6, filed Apr. 28, 2015, the disclosure of which is incorporated herein by reference.

### FIELD OF THE TECHNOLOGY

The disclosure relates to a machining system for aircraft structural components and a process for machining an aircraft structural component with a machining system.

### BACKGROUND

U.S. Pat. No. 8,220,134 B2 describes a machining system for aircraft structural components, in which a riveting unit having an upper tool and a lower tool is arranged in a C-shaped frame. A clamping frame is provided here for fastening an aircraft structural component and is held at two ends on a respective tower. The clamping frame is thus vertically displaceable and rotatable about a longitudinal axis separately at each end. The riveting unit in the C-shaped frame is displaceable as a whole along a horizontal X-axis and the towers are each displaceable in a horizontal Y-axis perpendicular to the X-axis.

From practice, machining systems are moreover known in which the riveting unit is held in a closed rectangular frame through which the clamping frame reaches. The riveting unit is displaceable in the Y-direction within this frame and the entire frame is displaceable in the X-direction. The towers here are arranged in a stationary manner and are not displaceable relative to a base.

For machining aircraft structural components, it is furthermore known to provide a riveting tool having an upper and lower tool at one end of a multi-axis robot arm. Such an arrangement is only suitable for components having a limited width.

### SUMMARY

It is an object of the disclosure to provide a machining system for aircraft structural components, which enables space-saving machining.

For a machining system described at the outset, this object can be achieved by features described herein. By providing a swivel bearing on the second frame, it is easily possible to achieve an alignment of the angle of the upper and lower tool with respect to a surface of the workpiece. In particular, the necessary movement of the workpiece by means of the second frame can thus be reduced. Moreover, for particularly strongly domed workpieces, or for workpieces having structures which are inclined relative to the surface, machining which cannot be achieved with conventional machining systems is enabled.

Within the context of various embodiments, a frame refers to any supporting and inherently rigid structure on which a component is held. A frame can comprise a plurality of mutually separate sub-components.

Within the context of various embodiments, a longitudinal direction, a transverse direction and optionally a vertical direction are defined, which are each at an angle to one another. Through a movement along the angled directions, it is thus possible to approach a point in space. Within the context of various embodiments, directions can refer to spatially fixed, unalterable directions or axes. In a concrete realization, these directions are often, but not necessarily, spatially fixed axes of a Cartesian coordinate system, wherein the axes are orientated at a right angle to one another. In this specific case, the longitudinal direction is also known as the X-axis, the transverse direction as the Y-axis and the vertical direction as the Z-axis.

A workpiece refers to a component of an aircraft structure which is to be machined by the machining system. In some embodiments, these are light metal components of the aircraft, for example fuselage, wing or tailplane parts, which are to be riveted.

A tool pair having an upper tool and a lower tool refers here in particular to any tool in which the upper tool and the lower tool have to simultaneously cooperate with the workpiece to achieve machining This results in corresponding demands relating to the displacement paths, the mounting and the precision of the positioning of the tool pair.

A machining system according to some embodiments is generally a computer-controlled system in which the positioning and machining procedures take place automatically by means of electric, hydraulic or other motors and/or actuators.

In an embodiment, the tool pair comprises a riveting tool or a combined tool for drilling and riveting. One of the two, in particular the upper tool, is formed here for supplying a rivet, wherein the other in each case, in particular the lower tool, functions as a counter-bearing during a deformation of the rivet. Corresponding demands are thus made on the introduction of force into the second frame. A combination of a drilling and riveting tool can be present, as is known in general and from the machining systems mentioned at the outset. After approaching a machining position, a hole can firstly be incorporated in the workpiece by means of a drilling tool, after which a rivet is incorporated and deformed in the hole by means of the combined riveting tool.

A swivel bearing or a swivel movement of the second frame generally refers to a movement about the swivel axis on which a linear movement perpendicular to the axis can also be superimposed. It would be possible to realize such a superimposed movement, for example, if the second frame were moved via a bearing in a guideway which is not curved circularly. In some embodiments, however, the swivel movement takes place as a simple rotation, wherein the swivel axis is formed as an axis of rotation. Such a rotation can take place via a simple pivot bearing acting as a swivel bearing.

The second frame is generally advantageously held on a base frame via the swivel bearing, wherein the base frame is displaceable in the longitudinal direction on a guide. This enables easy and, at the same time, precise positioning of the tool pair in the longitudinal direction. In other embodiments, however, the workpiece or the first frame could also be formed to be displaceable in the longitudinal direction.

In a particularly stable embodiment of the mounting of the tool pair, the second frame has a supporting structure encompassing the tool pair in a closed manner, wherein the workpiece reaches through an opening surrounded by the supporting structure. For example, this can be a rectangular frame in which the upper tool and the lower tool are held on mutually opposing sides of the frame.

At least one of the two, the upper tool or the lower tool, is generally advantageously adjustably displaceable relative to the second frame in a tool direction which is at an angle to the transverse direction. This enables particularly quick and precise positioning in the transverse direction. In other embodiments, the workpiece or the first frame can be additionally or alternatively formed to be displaceable in the transverse direction.

In an embodiment, the first frame comprises two positioning towers. The positioning towers can be positioned separately from one another in a stationary manner. The workpiece can be held between the positioning towers, wherein it is optionally movable by means of the positioning towers. Separate positioning of the positioning towers enables the system to be adapted to different sizes of workpiece. The positioning towers can be stationary in the sense that they are not movable during the machining of a workpiece.

The first frame generally advantageously has a first holder and a second holder, which are arranged at two opposing end regions of the workpiece, wherein the first holder is adjustably displaceable in a vertical direction which is at an angle to the longitudinal direction and also to the transverse direction. The angle of the workpiece can thus be positioned with respect to the tool pair. For further alignment, in an embodiment, the first holder is formed to be adjustably rotatable, wherein the workpiece is rotatable about a workpiece axis through the rotation of the first holder. The workpiece axis can extend in particular approximately along a longest length of the workpiece, whereby the rotation about the workpiece axis is particularly space-saving.

The second holder can furthermore also be adjustably displaceable in the vertical direction. Both a first end and a second end of the workpiece can thus be vertically displaced independently of one another, so that both an overall height and also an inclination of the workpiece about the transverse direction are adjustable. To compensate a change in the spacing between the holders which occurs during the vertical adjustment, a longitudinal compensation means, for example in the manner of a telescopic guide, can be formed on one of the holders in a known manner.

A clamping frame can be connected to the first holder and to the second holder, wherein the workpiece can be releasably fastened to the clamping frame and the clamping frame is movable by means of the holders. This also enables precise clamping and positioning of workpieces which are larger and have substantially any form. In alternative embodiments, however, the workpiece can also be arranged in a self-supporting manner between the holders.

An object of the disclosure is moreover achieved by a process for machining an aircraft structural component with a machining system according to the disclosure, comprising the steps:
a) clamping a workpiece which has a non-planar surface in the longitudinal direction, in particular a surface having a dome, in the first frame and calibrating a tool position relative to the workpiece;
b) approaching a first machining position and machining the workpiece;
c) approaching a second machining position which is different at least in the longitudinal direction, wherein the second frame is swiveled about the swivel axis depending on the surface of the workpiece in order to align the tool direction in its orientation with respect to the surface of the workpiece; and
d) machining the workpiece in the second machining position.

Through the provision of the swivel axis on the second frame, the adaptation of the tool direction or a machining direction when approaching the second machining position can take place quickly and easily. The tool direction here is aligned perpendicularly to the surface in the machining position. The tool direction refers in particular to the riveting direction when the tool pair is formed as a riveting tool.

An embodiment provides a machining system for aircraft structural components, comprising a first frame for mounting a workpiece, and a second frame for mounting a tool pair comprising an upper tool and a lower tool cooperating therewith, wherein the workpiece is positioned between the upper tool and the lower tool, wherein the second frame is formed to be displaceable at least in a longitudinal direction with respect to a base, and wherein the tool pair is held in the second frame such that it is displaceable in a transverse direction which is at an angle to the longitudinal direction, wherein the second frame is held on at least one swivel bearing so that the second frame can be adjustably swiveled together with the tool pair about a swivel axis.

In some embodiments, the tool pair comprises a riveting tool or a combined tool for drilling and riveting.

In some embodiments, the second frame is held on a base frame via the swivel bearing, wherein the base frame is displaceable in the longitudinal direction on a guide.

In some embodiments, the second frame comprises a supporting structure encompassing the tool pair in a closed manner, wherein the workpiece reaches through an opening surrounded by the supporting structure.

In some embodiments, at least one of the two, the upper tool or the lower tool, is adjustably displaceable relative to the second frame in a tool direction which is at an angle to the transverse direction.

In some embodiments, the first frame comprises two positioning towers which can be positioned in particular separately from one another in a stationary manner.

In some embodiments, the first frame has at least a first holder and a second holder, which are arranged at two opposing end regions of the workpiece, wherein the first holder is adjustably displaceable in a vertical direction which is at an angle to the longitudinal direction and the transverse direction.

In some embodiments, the first holder is adjustably rotatable, wherein the workpiece is rotatable about a workpiece axis through the rotation of the first holder.

In some embodiments, the second holder is also adjustably displaceable in a vertical direction.

In some embodiments, a clamping frame is connected to the first holder and to the second holder, wherein the workpiece can be releasably fastened to the clamping frame and the clamping frame is movable by means of the holders.

An embodiment provides a method for machining an aircraft structural component by means of a machining system according to the disclosure, characterized by the steps: clamping a workpiece which has a non-planar surface in the longitudinal direction, in particular a surface having a dome, in the first frame and calibrating a tool position relative to the workpiece; approaching a first machining position and machining the workpiece; approaching a second machining position which is different at least in the longitudinal direction, wherein the second frame is swiveled about the swivel axis depending on the surface of the workpiece in order to align the tool direction in its orientation with respect to the surface of the workpiece; machining the workpiece in the second machining position.

### BRIEF DESCRIPTION OF THE DRAWINGS

Further advantages and features of various embodiments are revealed in an exemplary embodiment described below and explained in more detail with reference to the accompanying drawings. The drawings show:

FIG. 1 a three-dimensional overall view of a machining system according to an embodiment;

FIG. 2 a schematic illustration of axes, directions and planes of the machining system of FIG. 1 in the machining position shown in FIG. 1;

FIG. 3 the schematic illustration of FIG. 2 in a second machining position; and

FIG. 4 the schematic illustration of FIG. 2 in a third machining position.

### DETAILED DESCRIPTION

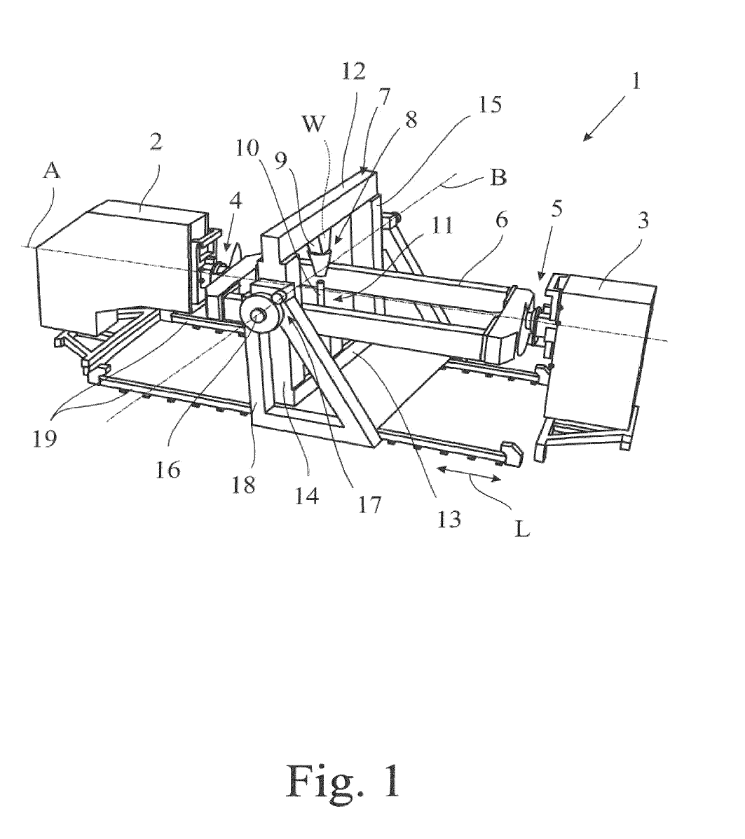

The machining system shown in FIG. 1 comprises a first frame 1, which comprises a first positioning tower 2 and a second positioning tower 3. Arranged on each of the positioning towers 2, 3 is a respective holder 4, 5, which are displaceable in each case in perpendicular and parallel vertical directions H1, H2 here by means of a controlled drive.

Each of the holders 4, 5 is rotatable about a workpiece axis A, wherein the orientation of the workpiece axis A depends on the respective position of the holders 4, 5 in the vertical directions H1, H2.

A clamping frame 6 is fastened between the holders 4, 5 so that the clamping frame 6 can be altered in terms of its spatial orientation by the movements of the holders 4, 5. To enable the separate vertical adjustment of the holders 4, 5 here, a longitudinal compensation means is provided on one of the holders 4, 5 in a known manner.

A workpiece (not illustrated) can be fastened in a stationary manner on the clamping frame 6 by holding elements, so that the workpiece can be spatially adjusted together with the clamping frame 6.

As a result of the individual vertical adjustability of the holders 4, 5 and the rotatability about the workpiece axis A, an overall adjustability of the workpiece is provided in three directions or axes A, H1, H2 by means of the first frame 1.

A second frame 7 supports a tool pair 8 which comprises an upper tool 9 and a lower tool 10. The tool pair 8 is formed overall as a combined tool for drilling and riveting. A bore can firstly be incorporated in the workpiece by means of the upper tool 9. A rivet is then inserted into the bore and deformed by means of a common interaction of the upper tool 9 and the lower tool 10.

The upper tool 9 and the lower tool 10 are each movable in a transverse direction Q in the second frame 7 so that the setting of a machining point can be adjusted substantially over a width of the second frame 7.

The second frame 7 has a supporting structure encompassing the tool pair in a closed manner, wherein the workpiece or the clamping frame 6 reaches through an opening 11 surrounded by the supporting structure. The supporting structure is formed here as a rectangle comprising two horizontal supports 12, 13 and two supports 14, 15 which are perpendicular thereto. Drives for the respective displacement of the upper tool 9 and lower tool 10 in the transverse direction Q are located in the horizontal supports 12, 13.

The upper tool 9 and the lower tool 10 are each adjustably displaceable relative to the second frame 7 in a tool direction W which is at an angle to the transverse direction Q. For riveting, the upper tool 9 and the lower tool 10 are aligned here with respect to the same axis extending in the tool direction W.

The second frame 7 is held on a swivel bearing 16 so that it can be swiveled about a swivel axis B. The swivel bearing 16 is formed as a pivot bearing here so that the swivel axis B is a central axis of rotation of the pivot bearing 16. The swivel movement of the second frame 7 takes place accordingly together with the tool pair 8 held on the second frame 7.

The swivel movement of the second frame 7 can be driven in a computer-controlled manner via a rotary drive 17. Overall, all of the movements of the machining system which are described above and below are driven in a computer-controlled manner.

The swivel bearing 16 is supported on a base frame 18 so that the second frame 7 is held on the base frame 18 via the swivel bearing 16. The second frame 7 is thus positioned high enough to enable it to swivel freely.

The base frame 18 is seated on a guide 19 which comprises two rails and extends in a longitudinal direction L which is at an angle to the transverse direction Q. The base frame is thus displaceable in a drivable manner on the guide 19 in the longitudinal direction L together with the second frame 7.

By means of the second frame 7 and its holder on the displaceable base frame 18, an adjustment of the machining point of the tool pair 8 can thus take place in three directions or axes, namely the transverse direction Q, the longitudinal direction L and the swivel axis B.

The extent of the clamping frame 6 is more than twice as long in the longitudinal direction L than in the transverse direction Q. The adjustment of an inclination of the clamping frame 6 about the transverse direction Q correspondingly means a long travel of the holders 4, 5 in the vertical direction. This can be restricted by a corresponding adjustment of the swivel angle of the second frame 7.

Various embodiments function as follows:

A workpiece (not illustrated) is firstly fastened on the empty clamping frame 6. The workpiece can have a dome, which at least partly has a curvature about the transverse direction so that it is not planar in the longitudinal direction. The position of the tool pair 8 is then calibrated relative to the workpiece.

A first machining position is then approached and the workpiece is machined in this position. To this end, a hole is drilled in the workpiece by means of the upper tool 9 and a rivet is inserted. The rivet is then deformed or closed through cooperation between the upper tool 9 and the lower tool 10.

A second machining position is then approached, which is different from the first machining position at least in the longitudinal direction L. Owing to the non-planarity of the workpiece in the longitudinal direction L, the second frame 7 here is swiveled about the swivel axis B depending on the surface of the workpiece. The tool direction W is thus newly aligned in terms of its orientation with respect to the surface of the workpiece and spatially. In particular, it is generally desirable during riveting that the tool direction W is aligned perpendicularly to the surface of the workpiece at the machining point.

The workpiece is then machined in the second machining position and optionally in further machining positions.

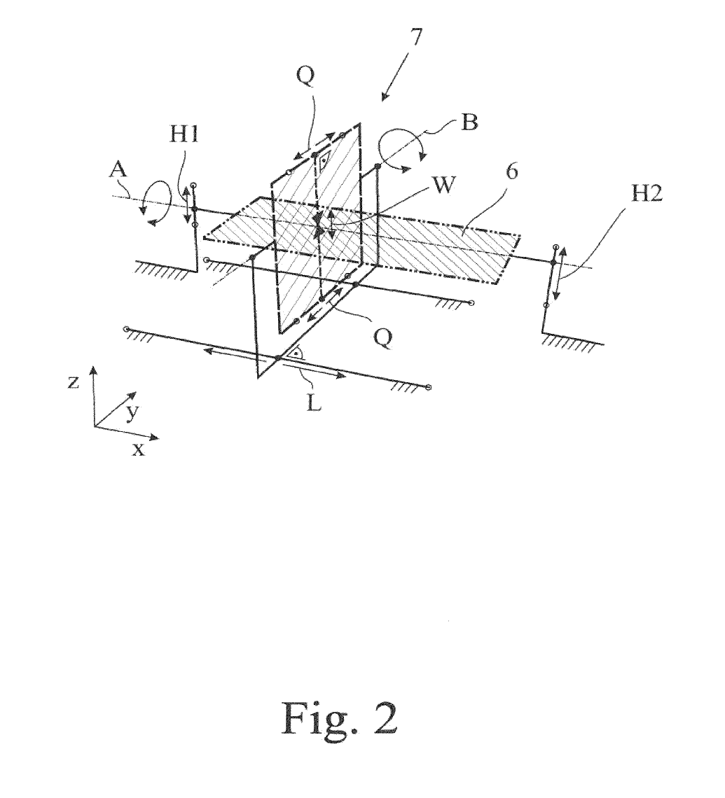

The movements of the clamping frame 6 and the workpiece and the tool pair 8 are also explained by the drawings FIG. 2 to FIG. 4. In FIG. 2, the same position of the machining system as in FIG. 1 is illustrated schematically.

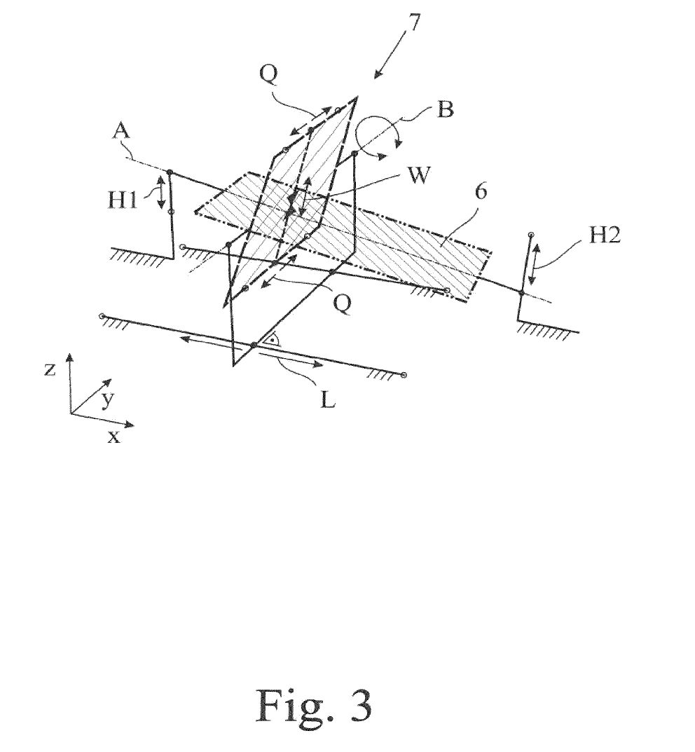

In FIG. 3, the holders 4, 5 have been displaced differently along the vertical directions H1, H2 so that the clamping frame 6 and therefore the workpiece axis A is tilted about the transverse direction Q. The second frame 7 has been swiveled about the swivel axis B so that the tool direction W is in turn perpendicular to the clamping frame 6.

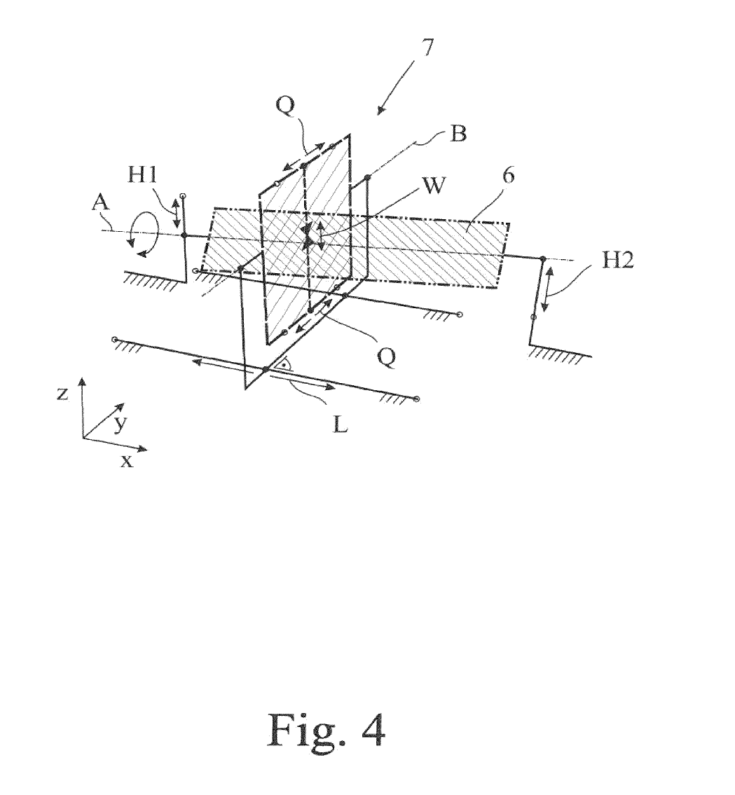

In FIG. 4, the clamping frame 6 has been additionally rotated about the workpiece axis A, wherein the tool direction W is not perpendicular to the clamping frame 6. This corresponds to a situation in which the surface of the workpiece at the machining point has a corresponding inclination in relation to the clamping frame 6 so that the tool direction W is adapted accordingly.

It should generally be noted that the mutual angular position of the directions L, Q and H1 and H2 is potentially, but not necessarily, at a right angle. In such a case, the directions correspond to a stationary Cartesian coordinate system comprising an X-, Y- and Z-direction (see also FIG. 2).

With regard to the tool direction W, this can be a direction which is not fully adjustable in a simple embodiment. Therefore, for example, it is possible to specify only an optionally small travel of the upper tool 9 for changing between two machining points. The lower tool here can have no travel or only a small travel, wherein a vertical adjustment of the workpiece when changing the machining point takes place through the vertical directions H1, H2. In such an embodiment, the machining system comprises a total of six freely movable axes: H1, H2, A, Q, L and B.

In an embodiment, both the upper tool 9 and the lower tool 10 can be displaceable through a relatively large travel along the tool direction W so that the tool direction W is formed as a full adjustment axis for adjusting the machining point. This enables the travel in the vertical directions H1 and H2 to be kept small. Depending on the length of the workpiece or the clamping frame 6, it is thus possible to also keep the overall height of the machining system low.

In a conceivable further development, when the adjustability of the tool pair 8 along the tool direction W is configured accordingly, it is also possible to dispense with the adjustment along one, in particular both, of the vertical directions H1, H2.

In an embodiment (not illustrated) it is finally the case that the first frame 1 essentially only comprises a single positioning tower, which holds the first frame 1 at the end. It is also conceivable that two of such frames 1 are provided, which are each provided with a single positioning tower. It can then be the case that the two frames 1 each span a frame surface and that the frame surfaces are always in a common plane.

1. A machining system for aircraft structural components, comprising:
a first frame for mounting a workpiece, and
a second frame for mounting a tool pair, wherein the tool pair comprises an upper tool and a lower tool cooperating therewith;
wherein the workpiece is positioned between the upper tool and the lower tool;
wherein the second frame is formed to be displaceable at least in a longitudinal direction with respect to a base;
wherein the tool pair is held in the second frame such that it is displaceable in a transverse direction which is at an angle to the longitudinal direction; and
wherein the second frame is held on at least one swivel bearing so that the second frame can be adjustably swiveled together with the tool pair about a swivel axis.

2. The machining system according to claim 1, wherein the tool pair comprises a riveting tool or a combined tool for drilling and riveting.

3. The machining system according to claim 1, wherein the second frame is held on a base frame via the swivel bearing, wherein the base frame is displaceable in the longitudinal direction on a guide.

4. The machining system according to claim 1, wherein the second frame comprises a supporting structure encompassing the tool pair in a closed manner, wherein the workpiece reaches through an opening surrounded by the supporting structure.

5. The machining system according to claim 1, wherein at least one of the two, the upper tool or the lower tool, is adjustably displaceable relative to the second frame in a tool direction which is at an angle to the transverse direction.

6. The machining system according to claim 1, wherein the first frame comprises two positioning towers which can be positioned separately from one another in a stationary manner.

7. The machining system according to claim 1, wherein the first frame comprises at least a first holder and a second holder, which are arranged at two opposing end regions of the workpiece, wherein the first holder is adjustably displaceable in a vertical direction which is at an angle to the longitudinal direction and the transverse direction.

8. The machining system according to claim 7, wherein the first holder is adjustably rotatable, wherein the workpiece is rotatable about a workpiece axis through the rotation of the first holder.

9. The machining system according to claim 7, wherein the second holder is also adjustably displaceable in a vertical direction.

10. The machining system according to claim 7, wherein a clamping frame is connected to the first holder and to the second holder, wherein the workpiece can be releasably fastened to the clamping frame and the clamping frame is movable by the holders.

11. A method for machining an aircraft structural component by a machining system according to claim 1, comprising:
clamping a workpiece which has a non-planar surface in the longitudinal direction in the first frame and calibrating a tool position relative to the workpiece;
approaching a first machining position and machining the workpiece;
approaching a second machining position which is different at least in the longitudinal direction, wherein the second frame is swiveled about the swivel axis depending on the surface of the workpiece in order to align the tool direction in its orientation with respect to the surface of the workpiece; and
machining the workpiece in the second machining position.

12. The method according to claim 11, wherein the non-planar surface comprises a surface having a dome.
